(19) United States
(12) Patent Application Publication
(10) Pub. No.: US 2025/0373471 A1
(43) Pub. Date: Dec. 4, 2025

(54) MULTI-USER MULTIPLE-INPUT-MULTIPLE-OUTPUT SYSTEMS, APPARATUSES, AND METHODS USING BEAMFORMING PRECODER FOR UPLINK TRANSMISSION

(71) Applicant: HUAWEI TECHNOLOGIES CO., LTD., Shenzhen (GD)

(72) Inventors: Jung Hoon SUH, Kanata, CA (US); Osama Aboul-Magd, Kanata, CA (US); Michael Montemurro, Toronto, CA (US); Yan Xin, Kanata, CA (US); Kwok Shum Au, Kanata, CA (US)

(21) Appl. No.: 19/300,918

(22) Filed: Aug. 15, 2025

Related U.S. Application Data
(63) Continuation of application No. PCT/CN2024/083067, filed on Mar. 21, 2024.

(51) Int. Cl. H04L 25/02; H04B 7/06; H04B 17/318

(52) U.S. Cl. CPC H04L 25/0204; H04B 7/0617; H04B 17/318; H04L 25/0242

(57) ABSTRACT

A method has the steps of: transmitting to a plurality of stations (STAs) a plurality of sets of precoder coefficients and a trigger for uplink (UL) data transmission; each set of precoder coefficients are obtained based on parameters of one or more estimated channels between an access point (AP) and a respective STA of the plurality of STAs.

### CROSS-REFERENCE TO RELATED APPLICATIONS

This application is a continuation of PCT International Patent Application Serial No. PCT/CN2024/083067 filed Mar. 21, 2024, which claims the benefit of U.S. Provisional Patent Application Ser. No. 63/453,795, filed Mar. 22, 2023, the content of each of which is incorporated herein by reference in its entirety.

### TECHNICAL FIELD

The present disclosure relates generally to multi-user (MU) multiple-input-multiple-output (MIMO) wireless systems, apparatuses, and methods, and in particular to MU-MIMO wireless systems, apparatuses, and methods using beamforming precoder for uplink transmission.

### BACKGROUND

In wireless communications, channel estimation is usually required for obtaining the channel matrix of a link between two communication devices. For example, an initiator may transmit predefined symbols to a responder. The responder may estimate the channel matrix using the received symbols and feedback the estimated channel matrix to the initiator as coefficients of the channel state information (CSI).

### SUMMARY

According to one aspect of this disclosure, there is provided a first method comprising: transmitting to a plurality of stations (STAs) a plurality of sets of precoder coefficients and a trigger for uplink (UL) data transmission; wherein each set of precoder coefficients are obtained based on parameters of one or more estimated channels between an access point (AP) and a respective STA of the plurality of STAs.

In some embodiments, said transmitting to the plurality of STAs the plurality of sets of precoder coefficients and the trigger for UL data transmission comprises: transmitting to the plurality of STAs a first frame comprising the plurality of sets of precoder coefficients and a second frame comprising the trigger for UL data transmission.

In some embodiments, the first and second frames are separated by an inter-frame space.

In some embodiments, said transmitting to the plurality of STAs the plurality of sets of precoder coefficients and the trigger for UL data transmission comprises: transmitting to the plurality of STAs a frame comprising the plurality of sets of precoder coefficients and the trigger for UL data transmission.

In some embodiments, the one or more sets of precoder coefficients are organized in a frame or sub-frame; the frame or sub-frame comprises a control field, and one or more precoder coefficients fields each comprising a respective one of the one or more sets of the precoder coefficients; and the control field comprises a plurality of STA-control subfields each corresponding to a respective one of the plurality of STAs.

In some embodiments, each of the plurality of STA-control subfield has 40 bits.

In some embodiments, each neighboring pair of STA-control subfield are separated by a first delimiter field.

In some embodiments, the frame or sub-frame comprises a plurality of precoder coefficients fields, and each neighboring pair of precoder coefficients fields are separated by a second delimiter field.

In some embodiments, each second delimiter field comprises bits of a predefined pattern and a predefined length.

In some embodiments, each second delimiter field comprises a two-byte number of all binary 1's.

In some embodiments, each STA-control subfield at least comprises: an association-identification (AID) subfield comprising an identifier (ID) of the corresponding STA; a Nc-index subfield and a Nr-index subfield for indicating a number of columns and a number of rows of a beamforming feedback matrix, respectively; a grouping subfield for indicating subcarrier grouping; and a codebook-information subfield for indicating a size of codebook entries.

In some embodiments, the AID subfield has 11 bits, the Nc-index subfield has four bits, the Nr-index subfield has four bits, the grouping subfield has two bits, the sounding-dialog-token-number subfield has six bits, and/or the codebook-information subfield has one bit.

In some embodiments, each STA-control subfield further comprises a sounding-dialog-token-number subfield for identifying a null data packet (NDP) announcement frame for the corresponding STA; or the control field further comprises a sounding-dialog-token-number subfield for identifying a NDP announcement frame for the plurality of STAs.

In some embodiments, each STA-control subfield further comprises: a remaining-feedback-segments subfield; a first-feedback-segment subfield; and a resource-unit allocation subfield.

In some embodiments, the remaining-feedback-segments subfield has three bits, the first-feedback-segment subfield has one bit, and/or the resource-unit allocation subfield has nine bits.

In some embodiments, the frame or sub-frame comprises a plurality of precoder coefficients fields, and each neighboring pair of precoder coefficients fields are separated by a second delimiter field; and each second delimiter field comprises a same content as the AID subfield of a preceding STA-control subfield.

In some embodiments, the control field further comprises a bandwidth subfield; or each STA-control subfield comprises a bandwidth subfield.

In some embodiments, the bandwidth subfield has three bits.

In some embodiments, the control field further comprises a number-of-AIDs subfield for indicating a total number of STAs in the control field.

In some embodiments, each set of precoder coefficients correspond to values of a submatrix of a precoder matrix; and wherein the precoder matrix is calculated based on an aggregated channel matrix comprising the parameters of the one or more estimated channels between the AP and each of the plurality of STAs.

In some embodiments, the precoder matrix is a precoder matrix P_{MMSE} for all sets of precoder coefficients; the precoder matrix P_{MMSE} is calculated as:

$${P}_{MMSE} = {{H}_{agg}^{H} ( {H}_{agg} {H}_{agg}^{H} + ρ )}^{- 1}$$

where superscript H represents a Hermitian operation, superscript −1 represents a matrix inverse operation, ρ is a N₁×N₁ diagonal matrix with each diagonal element being a signal-to-noise ratio (SNR) measured at a receiver chain of the AP, N₁≥1 is an integer representing a total number of antennas of the AP, a size of P_{MMSE} is (M₁+M₂+ . . . +M_{N})×N₁, (M₁+M₂+ . . . +M_{N})≤N₁, N≥1 is an integer representing a total number of the STAs, Mᵢ≥1 (i=1, 2, . . . , N) is an integer representing a total number of antennas of the i-th STA, and H_{agg} is the aggregated channel matrix:

$${H}_{agg} = [ \begin{matrix}{H}_{{N}_{1} \times {M}_{1}}^{1} & {H}_{{N}_{1} \times {M}_{2}}^{2} & … & {H}_{{N}_{1} \times {M}_{N}}^{N}\end{matrix} ]$$

where

$${H}_{{N}_{1} \times {M}_{i}}^{i}$$

is an i-th estimated matrix comprising the parameters of the one or more estimated channels between the AP and the i-th STA, and the size of H_{agg} is N₁×(M₁+M₂+ . . . +M_{N}); and the i-th set of precoder coefficients correspond to the values of the submatrix of the precoder matrix P_{MMSE} from

$$( {\sum }_{j = 0}^{i - 1} {M}_{j} + 1 ) - th$$

row and the

$$( {\sum }_{j = 0}^{i - 1} {M}_{j} + 1 ) - th$$

column of the precoder matrix P_{MMSE} and having a size of Mᵢ×Kᵢ, where M₀=0, Kᵢ represents a total number of spatial streams transmitted by the i-th STA to the AP, Kᵢ≤Mᵢ.

In some embodiments, the i-th set of precoder coefficients correspond to values in first Mᵢ rows and first Kᵢ columns of an i-th precoder matrix Zᵢ having a size of Mᵢ×Mᵢ, i=1, 2, . . . , N, N≥1 is an integer representing a total number of the STAs, Mᵢ≥1 is an integer representing a total number of antennas of the i-th STA, (M₁+M₂+ . . . +M_{N})≤N₁, N₁≥1 is an integer representing a total number of antennas of the AP, Kᵢ represents a total number of spatial streams transmitted by the i-th STA to the AP, Kᵢ≤Mᵢ; and the i-th precoder matrix Zᵢ is calculated as:

$${Z}_{i} = {{R}_{i}^{H} ( {R}_{i} {R}_{i}^{H} + ρ )}^{- 1}$$

where superscript H represents a Hermitian operation, superscript −1 represents a matrix inverse operation, ρ is a N₁×N₁ diagonal matrix with each diagonal element being a SNR measured at a receiver chain of the AP,

$${R}_{i} = {Q}_{i} {H}_{{N}_{1} \times {M}_{i}}^{i} , {Q}_{i}$$

contains containing Mᵢ rows a matrix P_{MMSE} having a size of (M₁+M₂+ . . . +M_{N})×N₁ and

$${P}_{MMSE} = [ \begin{matrix}{Q}_{1} \\ ⋮ \\ {Q}_{{N}_{1}}\end{matrix} ] ,$$

$${P}_{MMSE} = {{H}_{agg}^{H} ( {H}_{agg} {H}_{agg}^{H} + ρ )}^{- 1} ,$$

where H_{agg} is the aggregated channel matrix having a size of N₁×(M₁+M₂+ . . . +M_{N}):

$${H}_{agg} = [ \begin{matrix}{H}_{{N}_{1} \times {M}_{1}}^{1} {P}_{1} & {H}_{{N}_{1} \times {M}_{2}}^{2} {P}_{2} & ⋯ & {H}_{{N}_{1} \times {M}_{N}}^{N} {P}_{N}\end{matrix} ]$$

where

$${H}_{{N}_{1} \times {M}_{i}}^{i}$$

is an i-th estimated channel matrix comprising the parameters of the one or more estimated channels between the AP and the i-th STA, and Pᵢ is a right singular matrix of a singular value decomposition (SVD) of

$${H}_{{N}_{1} \times {M}_{i}}^{i} :$$

$${H}_{{N}_{1} \times {M}_{i}}^{i} = {U}_{i} {D}_{i} {P}_{i}$$

where Uᵢ is a left singular matrix, and Dᵢ is a diagonal matrix whose diagonal entries are singular values of

$${H}_{{N}_{1} \times {M}_{i}}^{i} .$$

In some embodiments, the i-th set of precoder coefficients (i=1, 2, . . . , N, N≥1 is an integer representing a total number of the STAs) are calculated by:
(i) calculating a SVD of an i-th estimated channel matrix

$${H}_{{N}_{1} \times {M}_{i}}^{i}$$

comprising the parameters of the one or more estimated channels between the AP and the i-th STA as:

$${H}_{{N}_{1} \times {M}_{i}}^{i} = {U}_{i} {D}_{i} {P}_{i}$$

where N₁≥1 is an integer representing a total number of antennas of the AP, Mᵢ≥1 (i=1, 2, . . . , N) is an integer representing a total number of antennas of the i-th STA, (M₁+M₂+ . . . +M_{N})≤N₁, Uᵢ is a left singular matrix, Dᵢ is a diagonal matrix whose diagonal entries are singular values

$${H}_{{N}_{1} \times {M}_{i}}^{i} ,$$

and Pᵢ is a right singular matrix;
(ii) obtaining the aggregated channel matrix H_{agg} as:

$${H}_{agg} = [ \begin{matrix}{H}_{{N}_{1} \times {M}_{1}}^{1} {P}_{1} & {H}_{{N}_{1} \times {M}_{2}}^{2} {P}_{2} & ⋯ & {H}_{{N}_{1} \times {M}_{N}}^{N} {P}_{N}\end{matrix} ]$$

where H_{agg} has a size of N₁×(M₁+M₂+ . . . +M_{N});
(iii) calculating a matrix P_{MMSE} having a size of (M₁+M₂+ . . . +M_{N})×N₁ as:

$${P}_{MMSE} = {{H}_{agg}^{H} ( {H}_{agg} {H}_{agg}^{H} + ρ )}^{- 1}$$

where superscript H represents a Hermitian operation, superscript −1 represents a matrix inverse operation, ρ is a N₁×N₁ diagonal matrix with each diagonal element being a SNR measured at a receiver chain of the AP;
(iv) obtaining a plurality of submatrices Q₁, . . . , Q_{N} from the matrix P_{MMSE} where Qᵢ contains containing Mᵢ rows of the matrix P_{MMSE} and

$${P}_{MMSE} = [ \begin{matrix}{Q}_{1} \\ ⋮ \\ {Q}_{{N}_{1}}\end{matrix} ] ;$$

(v) calculating:

$${Z}_{i} = {{R}_{i}^{H} ( {R}_{i} {R}_{i}^{H} + ρ )}^{- 1}$$

where

$${R}_{i} = {Q}_{i} {H}_{{N}_{1} \times {M}_{i}}^{i} ,$$

Zᵢ is a matrix having a size of Mᵢ×Mi;
(vi) replacing Pᵢ with Zᵢ;
(vii) repeating steps (ii) to (v) for at least once; and
(viii) obtaining a matrix Sᵢ containing values in first Mᵢ rows and first Kᵢ columns of the matrix Zᵢ, the values of the matrix Sᵢ being the i-th set of precoder coefficients.

In some embodiments, the first method further comprises: (i) calculating a SVD of each of a plurality of estimated channel matrices each comprising the parameters of the one or more estimated channels between the AP and the plurality of STAs to obtain a first precoder matrix for each of the plurality of STAs; (ii) obtaining a plurality of first product matrices each being a multiplication of one of the plurality of estimated channel matrices and the corresponding first precoder matrix; (iii) calculating a second precoder matrix based on an aggregated channel matrix comprising the plurality of first product matrices; (iv) obtaining a plurality of submatrices from the precoder matrix; (v) obtaining a plurality of second product matrices each being a multiplication of one of the plurality of submatrix and the corresponding estimated channel matrix; (vi) calculating a plurality of third precoder matrices each based on a corresponding one of the plurality of second product matrices; and (vii) obtaining each set of precoder coefficients as values of a submatrix of a corresponding one of the plurality of third precoder matrices.

In some embodiments, the first method further comprises: performing the following steps for at least once before performing step (vii): (vi-1) replacing values of the first precoder matrices with those of the third precoder matrices; and (vi-2) repeating steps (ii) to (vi).

According to one aspect of this disclosure, there is provided an apparatus comprising: one or more processors functionally connected to one or more memories storing instructions, and the one or more processors is configured to execute the instructions and cause the apparatus to perform the above-described first method.

According to one aspect of this disclosure, there is provided one or more non-transitory computer-readable storage devices comprising computer-executable instructions, wherein the instructions, when executed, cause one or more circuits to perform the above-described first method.

According to one aspect of this disclosure, there is provided a second method comprising: receiving from an AP a plurality of sets of precoder coefficients and a trigger for UL data transmission; and using one set of the plurality of sets of precoder coefficients for beamforming to transmit data to the AP; wherein each set of precoder coefficients are obtained based on parameters of one or more estimated channels between the AP and a respective STA of the plurality of STAs.

In some embodiments, said receiving from the AP the plurality of sets of precoder coefficients and the trigger for UL data transmission comprises: receiving from the AP a first frame comprising the plurality of sets of precoder coefficients and a second frame comprising the trigger for UL data transmission.

In some embodiments, the first and second frames are separated by an inter-frame space.

In some embodiments, said receiving from the AP the plurality of sets of precoder coefficients and the trigger for UL data transmission comprises: receiving from the AP a frame comprising the plurality of sets of precoder coefficients and the trigger for UL data transmission.

In some embodiments, the one or more sets of precoder coefficients are organized in a frame or sub-frame; the frame or sub-frame comprises a control field, and one or more precoder coefficients fields each comprising a respective one of the one or more sets of the precoder coefficients; and the control field comprises a plurality of STA-control subfields each corresponding to a respective one of the plurality of STAs.

In some embodiments, each of the plurality of STA-control subfield has 40 bits.

In some embodiments, each neighboring pair of STA-control subfield are separated by a first delimiter field.

In some embodiments, the frame or sub-frame comprises a plurality of precoder coefficients fields, and each neighboring pair of precoder coefficients fields are separated by a second delimiter field.

In some embodiments, each second delimiter field comprises bits of a predefined pattern and a predefined length.

In some embodiments, each second delimiter field comprises a two-byte number of all binary 1's.

In some embodiments, each STA-control subfield at least comprises: an AID subfield comprising an ID of the corresponding STA; a Nc-index subfield and a Nr-index subfield for indicating a number of columns and a number of rows of a beamforming feedback matrix, respectively; a grouping subfield for indicating subcarrier grouping; and a codebook-information subfield for indicating a size of codebook entries.

In some embodiments, the AID subfield has 11 bits, the Nc-index subfield has four bits, the Nr-index subfield has four bits, the grouping subfield has two bits, the sounding-dialog-token-number subfield has six bits, and/or the codebook-information subfield has one bit.

In some embodiments, each STA-control subfield further comprises a sounding-dialog-token-number subfield for identifying a NDP announcement frame for the corresponding STA; or the control field further comprises a sounding-dialog-token-number subfield for identifying a NDP announcement frame for the plurality of STAs.

In some embodiments, each STA-control subfield further comprises: a remaining-feedback-segments subfield; a first-feedback-segment subfield; and a resource-unit allocation subfield.

In some embodiments, the remaining-feedback-segments subfield has three bits, the first-feedback-segment subfield has one bit, and/or the resource-unit allocation subfield has nine bits.

In some embodiments, the frame or sub-frame comprises a plurality of precoder coefficients fields, and each neighboring pair of precoder coefficients fields are separated by a second delimiter field; and each second delimiter field comprises a same content as the AID subfield of a preceding STA-control subfield.

In some embodiments, the control field further comprises a bandwidth subfield; or each STA-control subfield comprises a bandwidth subfield.

In some embodiments, the bandwidth subfield has three bits.

In some embodiments, the control field further comprises a number-of-AIDs subfield for indicating a total number of STAs in the control field.

In some embodiments, each set of precoder coefficients correspond to values of a submatrix of a precoder matrix; and the precoder matrix is calculated based on an aggregated channel matrix comprising the parameters of the one or more estimated channels between the AP and each of the plurality of STAs.

In some embodiments, the precoder matrix is a precoder matrix P_{MMSE} for all sets of precoder coefficients; the precoder matrix P_{MMSE} is calculated as:

$${P}_{MMSE} = {{H}_{agg}^{H} ( {H}_{agg} {H}_{agg}^{H} + ρ )}^{- 1}$$

where superscript H represents a Hermitian operation, superscript −1 represents a matrix inverse operation, ρ is a N₁×N₁ diagonal matrix with each diagonal element being a signal-to-noise ratio (SNR) measured at a receiver chain of the AP, N₁≥1 is an integer representing a total number of antennas of the AP, a size of P_{MMSE} is (M₁+M_{2+ . . . +}M_{N})×N₁, (M₁+M₂+ . . . +M_{N})≤N₁, N≥1 is an integer representing a total number of the STAs, Mᵢ≥1 (i=1, 2, . . . , N) is an integer representing a total number of antennas of the i-th STA, and H_{agg} is the aggregated channel matrix:

$${H}_{agg} = [ \begin{matrix}{H}_{{N}_{1} \times {M}_{1}}^{1} & {H}_{{N}_{1} \times {M}_{2}}^{2} & ⋯ & {H}_{{N}_{1} \times {M}_{N}}^{N}\end{matrix} ]$$

where

$${H}_{{N}_{1} \times {M}_{i}}^{i}$$

is an i-th estimated channel matrix comprising the parameters of the one or more estimated channels between the AP and the i-th STA, and the size of H_{agg} is N₁×(M₁+M₂+ . . . +M_{N}); and the i-th set of precoder coefficients correspond to the values of the submatrix of the precoder matrix P_{MMSE} from

$$( {\sum }_{j = 0}^{i - 1} {M}_{j} + 1 ) - th$$

row and the

$$( {\sum }_{j = 0}^{i - 1} {M}_{j} + 1 ) - th$$

column of the precoder matrix P_{MMSE} and having a size of Mᵢ×Ki, where M₀=0, Kᵢ represents a total number of spatial streams transmitted by the i-th STA to the AP, Kᵢ≤Mᵢ.

In some embodiments, the i-th set of precoder coefficients correspond to values in first Mᵢ rows and first Kᵢ columns of an i-th precoder matrix Zᵢ having a size of Mᵢ X Mᵢ, i=1, 2, . . . , N, N≥1 is an integer representing a total number of the STAs, Mᵢ≥1 is an integer representing a total number of antennas of the i-th STA, (M₁+M₂+ . . . +M_{N})≤N₁, N₁≥1 is an integer representing a total number of antennas of the AP, Kᵢ represents a total number of spatial streams transmitted by the i-th STA to the AP, Kᵢ≤Mᵢ; and the i-th precoder matrix Zᵢ is calculated as:

$${Z}_{i} = {{R}_{i}^{H} ( {R}_{i} {R}_{i}^{H} + ρ )}^{- 1}$$

where superscript H represents a Hermitian operation, superscript −1 represents a matrix inverse operation, ρ is a N₁×N₁ diagonal matrix with each diagonal element being a SNR measured at a receiver chain of the AP,

$${R}_{i} = {Q}_{i} {H}_{{N}_{1} \times {M}_{i}}^{i} ,$$

Qᵢ contains containing Mᵢ rows a matrix P_{MMSE} having a size of (M₁+M₂+ . . . +M_{N})×N₁ and

$${P}_{MMSE} = [ \begin{matrix}{Q}_{1} \\ ⋮ \\ {Q}_{{N}_{1}}\end{matrix} ] ,$$

$${P}_{MMSE} = {{H}_{agg}^{H} ( {H}_{agg} {H}_{agg}^{H} + ρ )}^{- 1} ,$$

where H_{agg} is the aggregated channel matrix having a size of N₁×(M₁+M₂+ . . . +M_{N}):

$${H}_{agg} = [ \begin{matrix}{H}_{{N}_{1} \times {M}_{1}}^{1} {P}_{1} & {H}_{{N}_{1} \times {M}_{2}}^{2} {P}_{2} & ⋯ & {H}_{{N}_{1} \times {M}_{N}}^{N}\end{matrix} ]$$

where

$${H}_{{N}_{1} \times {M}_{i}}^{i}$$

is an i-th estimated channel matrix comprising the parameters of the one or more estimated channels between the AP and the i-th STA, and Pᵢ is a right singular matrix of a singular value decomposition (SVD) of

$${H}_{{N}_{1} \times {M}_{i}}^{i} :$$

$${H}_{{N}_{1} \times {M}_{i}}^{i} = {U}_{i} {D}_{i} {P}_{i}$$

where Uᵢ is a left singular matrix, and Dᵢ is a diagonal matrix whose diagonal entries are singular values of

$${H}_{{N}_{1} \times {M}_{i}}^{i} .$$

In some embodiments, the i-th set of precoder coefficients (i=1, 2, . . . , N, N≥1 is an integer representing a total number of the STAs) are calculated by:
(i) calculating a SVD of an i-th estimated channel matrix

$${H}_{{N}_{1} \times {M}_{i}}^{i}$$

comprising the parameters of the one or more estimated channels between the AP and the i-th STA as:

$${H}_{{N}_{1} \times {M}_{i}}^{i} = {U}_{i} {D}_{i} {P}_{i}$$

where N₁≥1 is an integer representing a total number of antennas of the AP, Mᵢ≥1 (i=1, 2, . . . , N) is an integer representing a total number of antennas of the i-th STA, (M₁+M₂+ . . . +M_{N})≤N₁, Uᵢ is a left singular matrix, Dᵢ is a diagonal matrix whose diagonal entries are singular values

$${H}_{{N}_{1} \times {M}_{i}}^{i}$$

(ii) obtaining the aggregated channel matrix H_{agg} as:

$${H}_{agg} = [ \begin{matrix}{H}_{{N}_{1} \times {M}_{1}}^{1} {P}_{1} & {H}_{{N}_{1} \times {M}_{2}}^{2} {P}_{2} & … & {H}_{{N}_{1} \times {M}_{N}}^{N} {P}_{N}\end{matrix} ]$$

where H_{agg} has a size of N₁×(M₁+M₂+ . . . +M_{N});
(iii) calculating a matrix P_{MMSE} having a size of (M₁+M₂+ . . . +M_{N})×N₁ as:

$${P}_{MMSE} = {{H}_{agg}^{H} ( {H}_{agg} {H}_{agg}^{H} + ρ )}^{- 1}$$

where superscript H represents a Hermitian operation, superscript −1 represents a matrix inverse operation, ρ is a N₁×N₁ diagonal matrix with each diagonal element being a SNR measured at a receiver chain of the AP;
(iv) obtaining a plurality of submatrices Q₁, . . . , Q_{N} from the matrix P_{MMSE} where Qᵢ contains containing Mᵢ rows of the matrix P_{MMSE} and

$${P}_{MMSE} = [ \begin{matrix}{Q}_{1} \\ ⋮ \\ {Q}_{{N}_{1}}\end{matrix} ] ;$$

(v) calculating:

$${Z}_{i} = {{R}_{i}^{H} ( {R}_{i} {R}_{i}^{H} + ρ )}^{- 1}$$

where

$${R}_{i} = {Q}_{i} {H}_{{N}_{1} \times {M}_{i}}^{i} ,$$

Zᵢ is a matrix having a size of Mᵢ×Mᵢ;
(vi) replacing Pᵢ with Zᵢ;
(vii) repeating steps (ii) to (v) for at least once; and
(viii) obtaining a matrix Sᵢ containing values in first Mᵢ rows and first Kᵢ columns of the matrix Zᵢ, the values of the matrix Sᵢ being the i-th set of precoder coefficients.

In some embodiments, the plurality of sets of precoder coefficients are calculated by:
(i) calculating a SVD of each of a plurality of estimated channel matrices each comprising the parameters of the one or more estimated channels between the AP and the plurality of STAs to obtain a first precoder matrix for each of the plurality of STAs;
(ii) obtaining a plurality of first product matrices each being a multiplication of one of the plurality of estimated channel matrices and the corresponding first precoder matrix;
(iii) calculating a second precoder matrix based on an aggregated channel matrix comprising the plurality of first product matrices;
(iv) obtaining a plurality of submatrices from the precoder matrix;
(v) obtaining a plurality of second product matrices each being a multiplication of one of the plurality of submatrix and the corresponding estimated channel matrix;
(vi) calculating a plurality of third precoder matrices each based on a corresponding one of the plurality of second product matrices; and
(vii) obtaining each set of precoder coefficients as values of a submatrix of a corresponding one of the plurality of third precoder matrices.

In some embodiments, the plurality of sets of precoder coefficients are calculated further by: performing the following steps for at least once before performing step (vii):
(vi-1) replacing values of the first precoder matrices with those of the third precoder matrices; and
(vi-2) repeating steps (ii) to (vi).

According to one aspect of this disclosure, there is provided an apparatus comprising: one or more processors functionally connected to one or more memories storing instructions, and the one or more processors is configured to execute the instructions and cause the apparatus to perform the above-described second method.

According to one aspect of this disclosure, there is provided one or more non-transitory computer-readable storage devices comprising computer-executable instructions, wherein the instructions, when executed, cause one or more circuits to perform the above-described second method.

By using the above-described methods, a plurality of STAs may use the precoder coefficients for beamforming to transmit their data frames to an AP simultaneously in an UL MU-MIMO manner.

### BRIEF DESCRIPTION OF THE DRAWINGS

FIG. 1 is a simplified schematic diagram showing a communication system, according to some embodiments of this disclosure;

FIG. 2 is a simplified schematic diagram of an access point (AP) of the communication network of the communication system shown in FIG. 1;

FIG. 3 is a simplified schematic diagram of a station (STA) of the communication system shown in FIG. 1;

FIG. 4 is a schematic diagram showing an exemplary sounding procedure for uplinks (ULs) of the communication system shown in FIG. 1 using multi-user multiple-input multiple-output (MU-MIMO) and beamforming;

FIG. 5 is a schematic diagram showing the structure of a precoder coefficients frame, according to some embodiments of this disclosure;

FIG. 6 is a schematic diagram showing the structure of a UL MU-MIMO control field of the precoder coefficients frame shown in FIG. 5, according to some embodiments of this disclosure;

FIG. 7 is a schematic diagram showing the structure of a STA-control subfield of the UL MU-MIMO control field shown in FIG. 6, according to some embodiments of this disclosure;

FIG. 8 is a schematic diagram showing the structure of the MIMO control field of the high-throughput (HT) and very-High-throughput (VHT) WLAN 802.11 Specification;

FIG. 9 is a schematic diagram showing the structure of the MIMO control field of the HE WLAN 802.11 (that is, IEEE 802.11ax or WI-FI® 6) Specification;

FIG. 10 is a schematic diagram showing the structure of the MIMO control field of the extremely-high-throughput (EHT) WLAN 802.11 (that is, IEEE 802.11be or WI-FI® 7) Specification;

FIG. 11 is a schematic diagram showing the structure of a UL MU-MIMO control field of the precoder coefficients frame shown in FIG. 5, according to some other embodiments of this disclosure;

FIG. 12 is a schematic diagram showing the structure of a UL MU-MIMO control field of the precoder coefficients frame shown in FIG. 5, according to yet some other embodiments of this disclosure;

FIG. 13 is a schematic diagram showing the structure of a STA-control subfield of the UL MU-MIMO control field shown in FIG. 12;

FIG. 14 is a schematic diagram showing the structure of a UL MU-MIMO control field of the precoder coefficients frame shown in FIG. 5, according to still some other embodiments of this disclosure;

FIG. 15 is a schematic diagram showing the structure of a STA-control subfield of the UL MU-MIMO control field shown in FIG. 14;

FIG. 16 is a schematic diagram showing the structure of a UL MU-MIMO control field of the precoder coefficients frame shown in FIG. 5, according to some other embodiments of this disclosure;

FIG. 17 is a schematic diagram showing the channels between an AP and a plurality of STAs of the communication system shown in FIG. 1;

FIG. 18 is a flowchart showing a minimum mean square error (MMSE) beamforming (MMSE BF) method or procedure performed by the AP shown in FIG. 17 for computing the precoder coefficients, according to some embodiments of this disclosure;

FIG. 19 shows the detail of the precoder computation step of the MMSE BF procedure shown in FIG. 18;

FIG. 20 is a schematic diagram showing a MMSE BF precoder matrix obtained in the precoder computation step shown in FIG. 20 for obtaining the precoder coefficients;

FIG. 21 shows the detail of the precoder computation step of the MMSE BF procedure shown in FIG. 18, according to some other embodiments of this disclosure;

FIG. 22 is a schematic diagram showing a MMSE BF precoder matrix obtained in the precoder computation step shown in FIG. 21 for obtaining the MMSE BF precoder submatrices; and

FIG. 23 shows the detail of the precoder computation step of the MMSE BF procedure shown in FIG. 18, according to yet some other embodiments of this disclosure.

### DETAILED DESCRIPTION

Embodiments disclosed herein relate to wireless systems, apparatuses, and methods using channel state information (CSI) normalization and quantization. The wireless systems, apparatuses, and methods disclosed herein may be any suitable systems, apparatuses, and methods for transmitting wireless signals. Examples of such systems may be WI-FI® systems (WI-FI is a registered trademark of Wi-Fi Alliance, Austin, TX, USA), 5G or 6G wireless mobile communication systems, and the like.

### A. System Structure

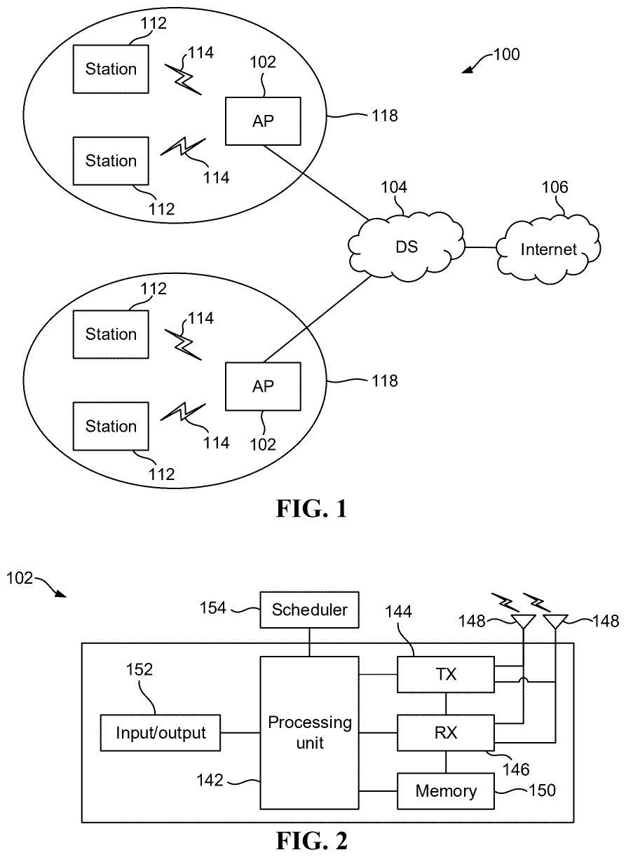

Turning now to FIG. 1, a communication system according to some embodiments of this disclosure is shown and is generally identified using reference numeral 100. As an example, the communication system 100 may be a WI-FI® system built under relevant standards such as IEEE 802. 11 standard. As shown, the communication system 100 comprises a plurality of interconnected networking devices 102 such as a plurality of interconnected access points (APs; also called “base stations”) forming a distribution system (DS) 104 which is in turn connected to other networks such as the Internet 108 which may include a network of computers and subnets (intranets) or both, and incorporate protocols, such as Internet Protocol (IP), Transmission Control Protocol (TCP), User Datagram Protocol (UDP), and/or the like.

Each AP 102 is in wireless communication with one or more mobile or stationary stations 112 (STAs) through respective wireless channels 114 for providing wireless network connects thereto. Herein, the APs 102 and STAs 112 may be considered as different types of network nodes (or simply “nodes”) of the communication system 100. Each AP 102 and the STAs 112 connected thereto form a cell or basic service set (BSS) 118.

FIG. 2 is a simplified schematic diagram of an AP 102. As shown, the AP 102 comprises at least one processing unit 142, at least one transmitter (Tx) 144, at least one receiver (Rx) 146 (collectively referred to as a transceiver), one or more antennas 148, at least one memory 150, and one or more input/output components or interfaces 152. A scheduler 154 may be coupled to the processing unit 142. The scheduler 154 may be included within or operated separately from the AP 102.

The processing unit 142 is configured for performing various processing operations such as signal coding, data processing, power control, input/output processing, or any other suitable functionalities. The processing unit 142 may comprise a microprocessor, a microcontroller, a digital signal processor, a FPGA, an ASIC, and/or the like. In some embodiments, the processing unit 142 may execute computer-executable instructions or code stored in the memory 150 to perform various the procedures (otherwise referred to as methods) described below.

Each transmitter 144 may comprise any suitable structure for generating signals, such as control signals as described in detail below, for wireless transmission to one or more STAs 112. Each receiver 146 may comprise any suitable structure for processing signals received wirelessly from one or more STAs 112. Although shown as separate components, at least one transmitter 144 and at least one receiver 146 may be integrated and implemented as a transceiver. Each antenna 148 may comprise any suitable structure for transmitting and/or receiving wireless signals. Although common antennas 148 are shown in FIG. 2 as being coupled to both the transmitter 144 and the receiver 146, one or more antennas 148 may be coupled to the transmitter 144, and one or more other antennas 148 may be coupled to the receiver 146.

In some embodiments, an AP 102 may comprise a plurality of transmitters 144 and receivers 146 (or a plurality of transceivers) together with a plurality of antennas 148 for communication in its cell 118.

Each memory 150 may comprise any suitable volatile and/or non-volatile storage such as RAM, ROM, hard disk, optical disc, SIM card, solid-state memory, memory stick, SD memory card, and/or the like. The memory 150 may be used for storing instructions executable by the processing unit 142 and data used, generated, or collected by the processing unit 142. For example, the memory 150 may store instructions of software, software systems, or software modules that are executable by the processing unit 142 for implementing some or all of the functionalities and/or embodiments of the procedures performed by an AP 102 described herein.

Each input/output component 152 enables interaction with a user or other devices in the communication system 100. Each input/output device 152 may comprise any suitable structure for providing information to or receiving information from a user and may be, for example, a speaker, a microphone, a keypad, a keyboard, a display, a touch screen, a network communication interface, and/or the like.

Herein, the STAs 112 may be any suitable wireless device that may join the communication system 100 via an AP 102 for wireless operation. In various embodiments, a STA 112 may be a wireless electronic device used by a human or user (such as a smartphone, a cellphone, a personal digital assistant (PDA), a laptop, a desktop computer, a tablet, a smart watch, a consumer electronics device, and/or the like). A STA 112 may alternatively be a wireless sensor, an Internet-of-things (IoT) device, a robot, a shopping cart, a vehicle, a smart TV, a smart appliance, a wireless transmit/receive unit (WTRU), a mobile station, or the like. Depending on the implementation, the STA 112 may be movable autonomously or under the direct or remote control of a human, or may be positioned at a fixed position.

In some embodiments, a STA 112 may be a multimode wireless electronic device capable of operation according to multiple radio access technologies and incorporate multiple transceivers necessary to support such.

In addition, some or all of the STAs 112 comprise functionality for communicating with different wireless devices and/or wireless networks via different wireless links using different wireless technologies and/or protocols. Instead of wireless communication (or in addition thereto), the STAs 112 may communicate via wired communication channels to other devices or switches (not shown), and to the Internet 106. For example, a plurality of STAs 112 (such as STAs 112 in proximity with each other) may communicate with each other directly via suitable wired or wireless sidelinks.

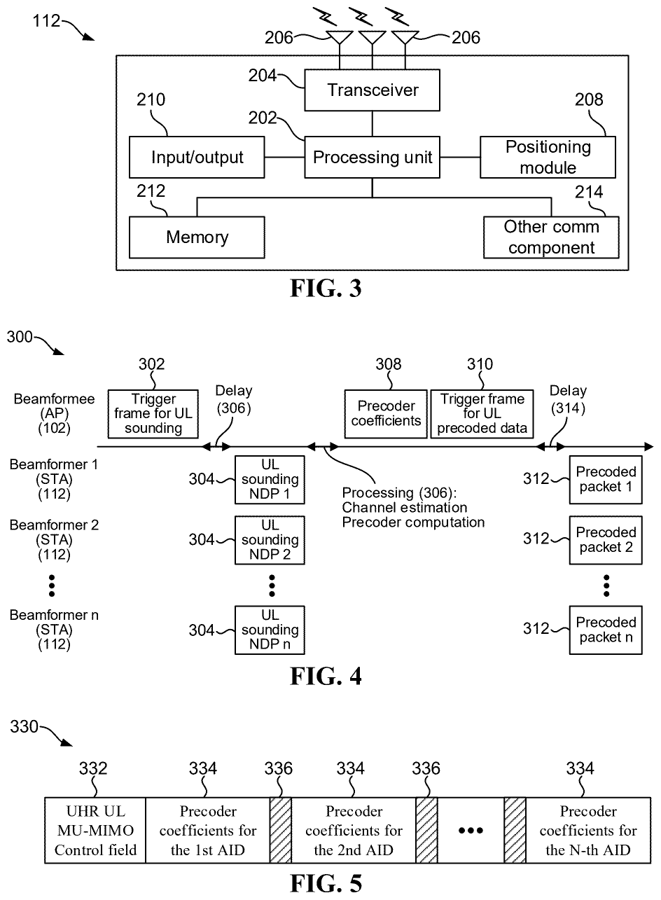

FIG. 3 is a simplified schematic diagram of a STA 112. As shown, the STA 112 comprises at least one processing unit 202, at least one transceiver 204, at least one antenna or network interface controller (NIC) 206, at least one positioning module 208, one or more input/output components 210, at least one memory 212, and at least one other communication component 214.

The processing unit 202 is configured for performing various processing operations such as signal coding, data processing, power control, input/output processing, or any other functionalities to enable the STA 112 to access and join the communication system 100 and operate therein. The processing unit 202 may also be configured to implement some or all of the functionalities of the STA 112 described in this disclosure. The processing unit 202 may comprise a central processing unit (CPU), a microprocessor, a microcontroller, a digital signal processor, an accelerator, a graphic processing unit (GPU), a tensor processing unit (TPU), a FPGA, or an ASIC. Examples of the processing unit 202 may be an ARM® microprocessor (ARM is a registered trademark of Arm Ltd., Cambridge, UK) manufactured by a variety of manufactures such as Qualcomm of San Diego, California, USA, under the ARM® architecture, an INTEL® microprocessor (INTEL is a registered trademark of Intel Corp., Santa Clara, CA, USA), an AMD® microprocessor (AMD is a registered trademark of Advanced Micro Devices Inc., Sunnyvale, CA, USA), and the like. In some embodiments, the processing unit 202 may execute computer-executable instructions or code stored in the memory 212 to perform various processes described below.

The at least one transceiver 204 may be configured for modulating data or other content for transmission by the at least one antenna 206 to communicate with an AP 102. The transceiver 204 is also configured for demodulating data or other content received by the at least one antenna 206. Each transceiver 204 may comprise any suitable structure for generating signals for wireless transmission and/or processing signals received wirelessly. Each antenna 206 may comprise any suitable structure for transmitting and/or receiving wireless signals. Although shown as a single functional unit, a transceiver 204 may be implemented separately as at least one transmitter and at least one receiver.

The positioning module 208 is configured for communicating with a plurality of global or regional positioning devices such as navigation satellites for determining the location of the STA 112. The navigation satellites may be satellites of a global navigation satellite system (GNSS) such as the Global Positioning System (GPS) of USA, Global'naya Navigatsionnaya Sputnikovaya Sistema (GLONASS) of Russia, the Galileo positioning system of the European Union, and/or the Beidou system of China. The navigation satellites may also be satellites of a regional navigation satellite system (RNSS) such as the Indian Regional Navigation Satellite System (IRNSS) of India, the Quasi-Zenith Satellite System (QZSS) of Japan, or the like. In some other embodiments, the positioning module 208 may be configured for communicating with a plurality of indoor positioning device for determining the location of the STA 112.

The one or more input/output components 210 is configured for interaction with a user or other devices in the communication system 100. Each input/output component 210 may comprise any suitable structure for providing information to or receiving information from a user and may be, for example, a speaker, a microphone, a keypad, a keyboard, a display, a touch screen, and/or the like.

The at least one memory 212 is configured for storing instructions executable by the processing unit 202 and data used, generated, or collected by the processing unit 202. For example, the memory 212 may store instructions of software, software systems, or software modules that are executable by the processing unit 202 for implementing some or all of the functionalities and/or embodiments of the STA 112 described herein. Each memory 212 may comprise any suitable volatile and/or non-volatile storage and retrieval components such as RAM, ROM, hard disk, optical disc, SIM card, solid-state memory modules, memory stick, SD memory card, and/or the like.

The at least one other communication component 214 is configured for communicating with other devices such as other STAs 112 via other communication means such as a radio link, a BLUETOOTH® link (BLUETOOTH is a registered trademark of Bluetooth Sig Inc., Kirkland, WA, USA), a wired sidelink, and/or the like. Examples of the wired sidelink may be a USB cable, a network cable, a parallel cable, a serial cable, and/or the like.

In some embodiments, a STA 112 may comprise a plurality of transceivers 204 and a plurality of antennas 206 for communication with an AP 102.

In the communication between the AP 102 and the STA 112, a transmission from the STA 112 to the AP 102 is usually denoted an uplink and the wireless channel used therefor is denoted an uplink channel. A transmission from the AP 102 to the STA 112 is usually denoted a downlink and the wireless channel used therefor is denoted a downlink channel. Suitable modulation technologies may be used for communication between the AP 102 and the STA 112. For example, in some embodiments, orthogonal frequency-division multiplexing (OFDM) may be used wherein the channel 114 is partitioned into a plurality orthogonal subchannels for communication between the AP 102 and the STA 112. Moreover, as there are usually a plurality of STAs 112 in communication with a same AP 102, suitable multiple-access technologies may be used. For example, in some embodiments, orthogonal frequency-division multiple access (OFDMA) may be used for communication between the AP 102 and STAs 112.

### B. Channel Estimation

With the use of a plurality of antennas at the AP side and/or at the STA side, the AP 102 and the STA 112 may use multiple-input multiple-output (MIMO) technologies for communication therebetween, wherein such a system 100 may be denoted a “MIMO system”. For example, in the 802.11ax standard (also denoted WI-FI® 6 or “High Efficiency (HE)”), uplink multi-user MIMO (UL MU-MIMO) may be used.

Moreover, the use of a plurality of antennas at the AP side and/or at the STA side allows the use of beamforming (BF) technologies, wherein such a system 100 may be denoted a “beamformed (BFed) MU-MIMO system”. The reference entitled “Uplink MU MIMO Improvements” to R. Strobel et al., presented in the ultra-high reliability (UHR) discussion, IEEE 802.11 UHR SG, January 2023, 23/27r1 proposes the use of BF technologies in UL MU-MIMO with a sounding prior to the BFed UL MU-MIMO, and proposes a sounding protocol therefor. However, the detail of precoder coefficients format and the detail of computing the precoder coefficients are not provided in this reference.

FIG. 4 is a schematic diagram showing a sounding procedure 300 for estimating an UL channel between an AP 102 (also denoted a “beamformee”) and a plurality of STAs 112 (also denoted “beamformers”). When the sounding procedure 300 starts, the AP 102 first sends to the STAs 112 a trigger frame 302 for triggering UL sounding. After receiving the trigger frame 302, each STA 112 responses with a UL sounding null data packet (NDP) 304 to the AP 102. There may be a delay 306 between the trigger frame 302 and the NDPs 306.

The AP 102 then uses the received NDPs 306 to estimate the channel between the AP 102 and each STA 112, and, based on the estimated channels, calculates a precoding matrix collectively for all STAs 112 (that is, having the precoder coefficients for all STAs 112), wherein each STA 112 may implement its portion of the precoding matrix. The AP 102 then sends the precoding matrix 308 as a precoder coefficients frame 308 (which is an action frame) to the STAs 112, and also sends a trigger frame 310 thereto for triggering transmission of UL precoded data (which is a control frame). After receiving the precoder coefficients frame 308, each STA 112 decodes or otherwise retrieves its precoder coefficients (that is, its portion of the precoding matrix) from the precoder coefficients frame 308. In some embodiments, there may be a short inter-frame space (SIFS) between the precoder coefficients frame 308 and the trigger frame 310. Alternatively, the AP 102 may combine the precoder coefficients frame 308 and the trigger frame 310 as an integrated control frame for sending to each STA 112.

After receiving from the AP 102 a trigger frame 310 for UL precoded data, each STA 112 uses its portion of the precoding matrix (that is, its precoder coefficients) to precode the data to be transmitted (for UL beamforming) and transmit the precoded data 312 to the AP 102 as, for example, data packets. There may be a delay 314 between the trigger frame 310 and the data packets 312.

In the following the structure of the precoder coefficients frame is first described. Then, the methods of computing the precoder coefficients are described. The precoder coefficients frame and the computation methods of the precoder coefficients described herein may be used in UHR WLAN 802.11 (that is, WI-FI® 8) Specification or other relevant standards and/or technologies.

FIG. 5 is a schematic diagram showing the structure of the precoder coefficients frame 330, which may be used as a separate action frame (such as the frame 308 shown in FIG. 4) or concatenated with the trigger frame 310 to form an integrated control frame. As shown, the precoder coefficients frame 330 comprises a MIMO control field 332 (also denoted “UHR UL MU-MIMO control field”) followed by one or more precoder coefficients fields 334 each comprising the precoder coefficients for a respective STA 112. In these embodiments, each neighboring pair of precoder coefficients fields 334 are separated by a delimiter 336.

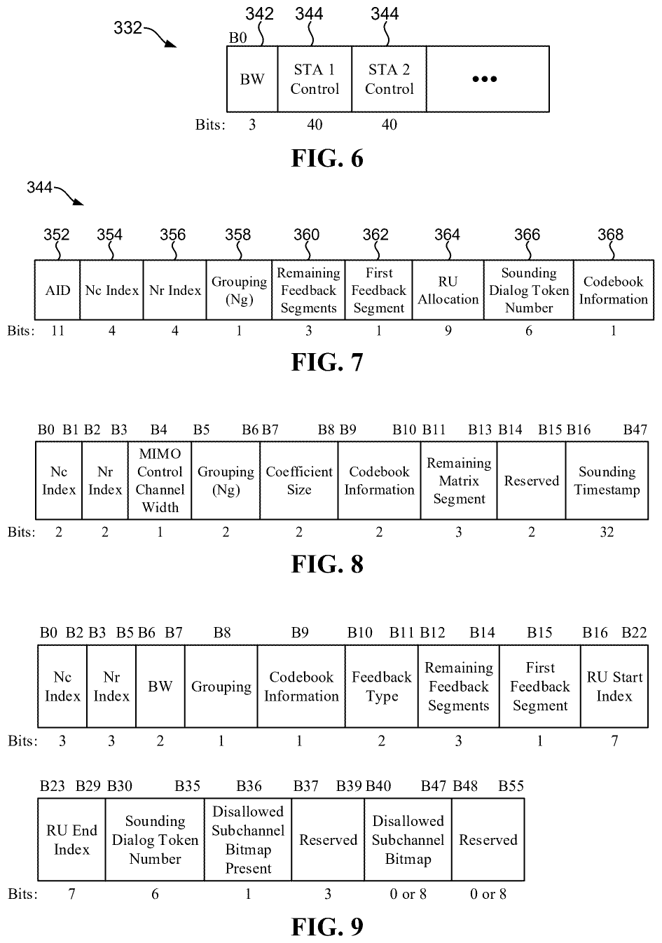

FIG. 6 is a schematic diagram showing the structure of the UHR UL MU-MIMO control field 332, which comprises a bandwidth (BW) subfield 342 for indicating the channel width, followed by one or more STA-control subfields 344 each comprises the control parameters for a corresponding STA 112. The number of STA-control subfields 344 listed in the UHR UL MU-MIMO control field 332 depends on the number of UL MU-MIMO scheduled STAs 112.

In some embodiments, the BW subfield 342 is a three-bit subfield common to all STAs 112 included in the UHR UL MU-MIMO control field 332, and each STA-control subfield 344 is a 40-bit subfield.

FIG. 7 is a schematic diagram showing the structure of the STA-control subfield 344 according to some embodiments of this disclosure. The STA-control subfield 344 comprises:
a 11-bit association identification (AID) subfield 352 (which may also be denoted a “subsubfield”) containing the identifier (ID) of a corresponding STA 110,
a four-bit Nc-index subfield 354 and a four-bit Nr-index subfield 356 for indicating the number of columns and the number of rows of the compressed beamforming feedback matrix, respectively, (thereby indicating the size thereof),
a two-bit grouping (Ng) subfield 358 for indicating the number of subcarriers that are grouped together;
a three-bit remaining-feedback-segments subfield 360 and a one-bit first-feedback-segment subfield 362 for indicating the segmenting of the channel feedback report to be sent from the beamformee (for example, the AP 102) to the beamformer (for example, the STA 112),
a nine-bit resource unit (RU) allocation subfield 364 for indicating the RUs allocated to the STA 112 (which may be required if OFDMA is used), where the precoder of the corresponding STA needs to be applied,
a six-bit sounding-dialog-token-number subfield 366 for identifying the NDP announcement frame, and
a one-bit codebook-information subfield 368 for indicating the size of the codebook quantization.

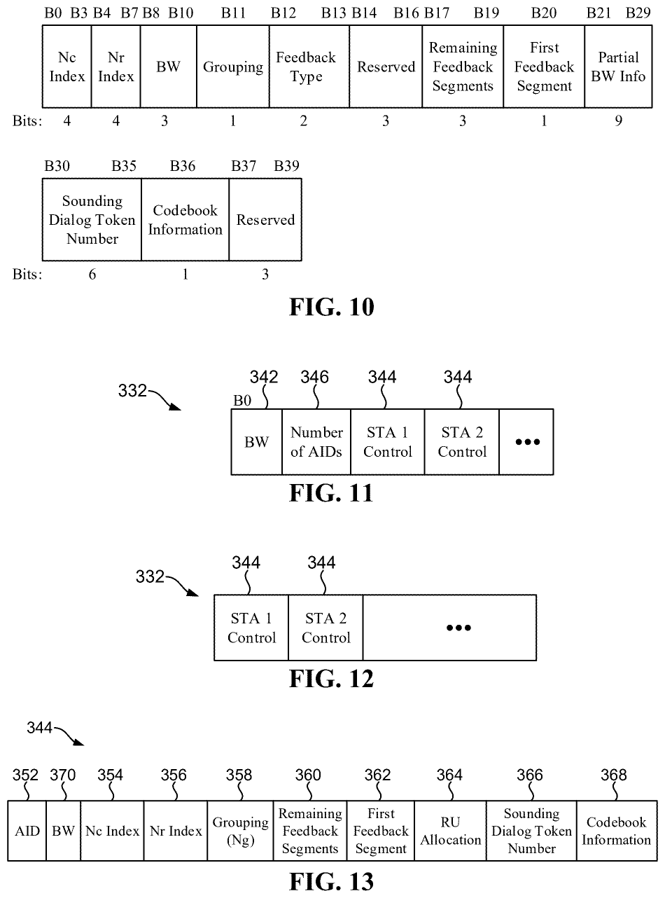

As a comparison, FIG. 8 shows the structure of the MIMO control field of the high-throughput (HT) and very-High-throughput (VHT) WLAN 802.11 Specification, FIG. 9 shows the structure of the MIMO control field of the HE WLAN 802.11 (that is, IEEE 802.11ax or WI-FI® 6) Specification, and FIG. 10 shows the structure of the MIMO control field of the extremely-high-throughput (EHT) WLAN 802.11 (that is, IEEE 802.11be or WI-FI® 7) Specification.

Referring again to FIG. 5, in some embodiments, each delimiter 336 may be the same as the AID 352 of the preceding STA-control subfield 344. In some other embodiments, each delimiter 336 may comprise bits of a predefined pattern and a predefined length such as a two-byte (that is, 16-bit) number of all binary 1's (one) (that is, “FF” in hexagonal representation).

Those skilled in the art will appreciate that, in various embodiments, the number of bits in each field or subfield of the precoder coefficients frame 330 may vary from the example shown in FIGS. 5 to 7, and the order of the fields and/or subfields of the precoder coefficients frame 330 may vary from the example shown in FIGS. 5 to 7.

Moreover, in various embodiments, the precoder coefficients frame 330 may comprise more or less fields and/or subfields than the example shown in FIGS. 5 to 7. For example, in some embodiments, the STA-control subfield 344 may only comprise the AID subfield 352, the Nc-index subfield 354, Nr-index subfield 356, the grouping subfield 358, the sounding dialog token number subfield 366, and codebook information subfield 368.

In some embodiments as shown in FIG. 11, the UHR UL MU-MIMO control field 332 may further comprise a number-of-AIDs subfield 346 between the BW subfield 342 and the first STA-control subfield 344, wherein the number-of-AIDs subfield 346 may be used for indicating the total number of STAs 112 in the UHR UL MU-MIMO control field 332 (that is, indicating how many AIDs 352 are listed in the UHR UL MU-MIMO control field 332).

As shown in FIGS. 12 and 13, in some embodiments wherein OFDMA is used, the UHR UL MU-MIMO control field 332 may not comprise a BW subfield 342 common to all STAs 102. Rather, each STA-control subfield 344 may comprise its own BW subfield 370.

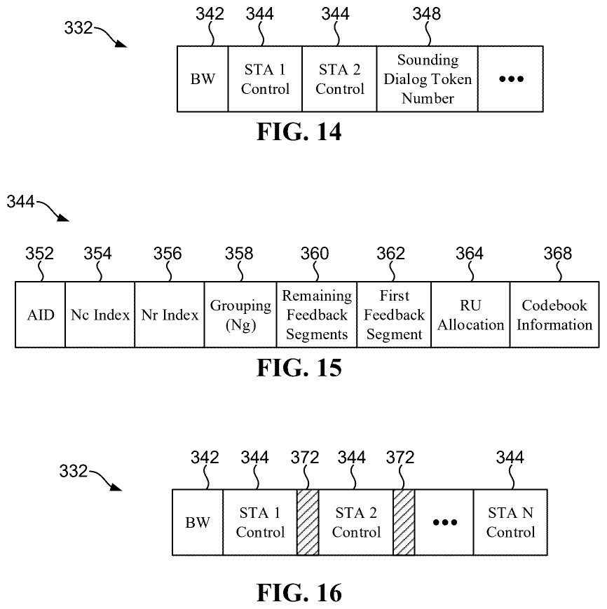

In some embodiments as shown in FIGS. 14 and 15, the STA-control subfields 344 may not comprise their own sounding-dialog-token-number subfield. Rather, the UHR UL MU-MIMO control field 332 may comprise a sounding-dialog-token-number subfield 348 common to all STAs 112.

In some embodiments as shown in FIG. 16, each neighboring pair of the STA-control subfields 344 may be separated by a delimiter 372.

In some embodiments, depending on the total necessary bits and the Octet size in the UHR UL MU-MIMO control field 332, the UHR UL MU-MIMO control field 332 may comprise one or more reserved subfields at the end or in the middle thereof for the purpose of, for example, alignment (that is, making the UHR UL MU-MIMO control field 332 in the length of one or more bytes).

The methods of computing the precoder coefficients are now described.

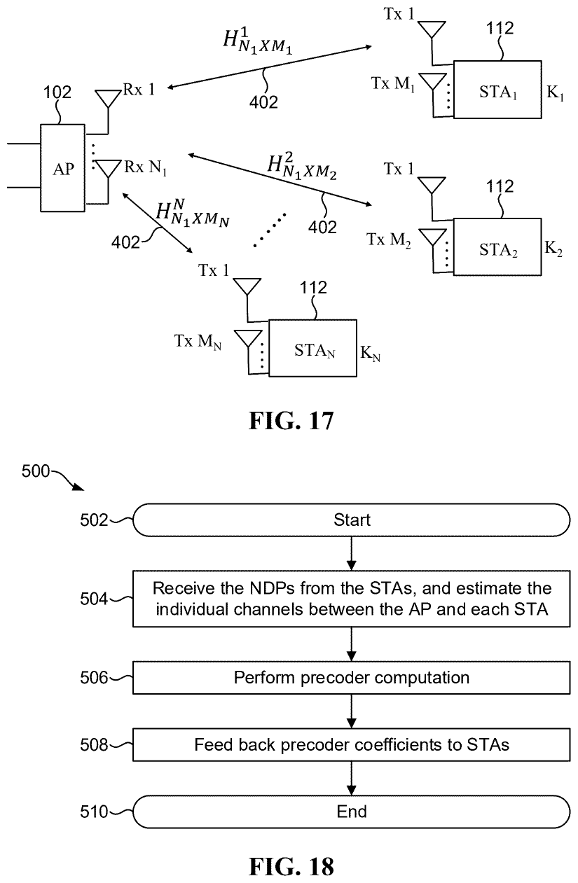

Referring to FIG. 17, the UL channels 402 are the wireless channels from the STAs 112 to the AP 102 with the channel matrix of the i-th STA represented as

$${H}_{{N}_{1} \times {M}_{i}}^{i} ,$$

where 1≤i<N with N≥1 is an integer (that is, there are N STAs 112), N₁≥1 is an integer representing the number of antennas of the AP 102, Mᵢ≥1 is an integer representing the number of antennas of the i-th STA 112, and (M₁+M₂+ . . . +M_{N})≤N₁.

FIG. 18 is a flowchart showing a minimum mean square error (MMSE) beamforming (MMSE BF) method or procedure 500 performed by the AP 102 for computing the precoder coefficients, according to some embodiments of this disclosure. In the following, the MMSE BF method is described with reference to FIG. 17.

When the MMSE BF procedure 500 starts (step 502), the AP 102 receives the NDPs from the STAs 112, and estimates the channel matrix

$${H}_{{N}_{1} \times {M}_{i}}^{i} ( i = 1 , ... , N )$$

between the AP 102 and each STA 112 (step 504). At step 506, the AP 102 performs precoder computation based on the estimated channel matrices to obtain a precoder-coefficients submatrix for each UL channel. The obtained precoder-coefficients submatrices are then fed back to the respective STAs 112 (step 508), and the MMSE BF procedure 500 ends (step 510).

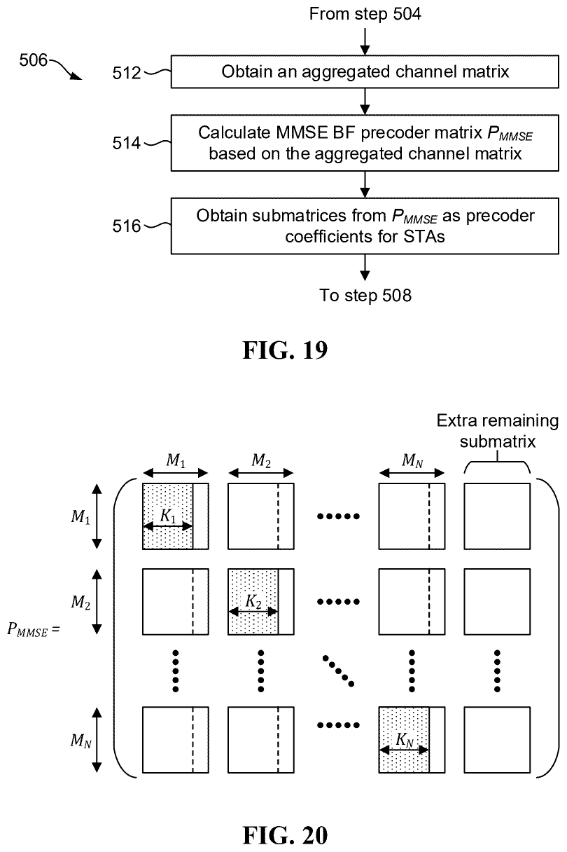

The detail of the precoder computation (that is, step 506) is shown in FIG. 19. Let K₁, K₂, . . . , K_{N} respectively represent the actual numbers of spatial streams transmitted by the respective STAs 112 to the AP 102 through the UL channels thereof, where K₁≤M₁, K₂≤M₂, . . . , K_{N}≤M_{N}.

At step 512, the AP 102 aggregates the estimated channel matrices

$${H}_{{N}_{1} \times {M}_{i}}^{i}$$

of all channels into an aggregated channel matrix H_{agg}:

$${H}_{agg} = [ \begin{matrix}{H}_{{N}_{1} \times {M}_{1}}^{1} & {H}_{{N}_{1} \times {M}_{2}}^{2} & … & {H}_{{N}_{1} \times {M}_{N}}^{N}\end{matrix} ]$$

wherein the size of H_{agg} is N₁×(M₁+M₂+ . . . +M_{N}).

At step 514, the AP 102 calculates the MMSE BF precoder matrix P_{MMSE} based on the aggregated channel matrix H_{agg} as:

$${P}_{MMSE} = {{H}_{agg}^{H} ( {H}_{agg} {H}_{agg}^{H} + ρ )}^{- 1}$$

where the superscript H represents a Hermitian operation, the superscript −1 represents a matrix inverse operation, and ρ is a N₁×N₁ diagonal matrix with each diagonal element being the signal-to-noise ratio (SNR) measured at each Rx chain of the AP 102. The size of P_{MMSE} is (M₁+M₂+ . . . +M_{N})×N₁.

At step 516, the AP 102 obtains the precoder coefficients from P_{MMSE} for the STAs 112, wherein the precoder coefficients for each STA 112 is a submatrix along the diagonal of the MMSE BF precoder matrix P_{MMSE}. The AP 102 then goes to step 508 to feed back the obtained precoder-coefficients submatrices to the respective STAs.

Referring to FIG. 20, the precoder-coefficients submatrix Sᵢ for the first STA starts from the first row and the first column of P_{MMSE}, and has a size of M₁×K₁ (that is, M₁ rows and K₁ columns). The precoder-coefficients submatrix S₂ for the second STA starts from the (M₁+1)-th row and the (M₁+1)-th column of P_{MMSE}, and has a size of M₂×K₂. Generally, the precoder-coefficients submatrix Sᵢ for the i-th STA (i=₁, . . . , N) starts from the

$$( \sum \begin{matrix}i - j \\ j = 0\end{matrix} {M}_{j} + 1 ) - th$$

row and the

$$( \sum \begin{matrix}i - j \\ j = 0\end{matrix} {M}_{j} + 1 ) - th$$

column of P_{MMSE} (where M₀=0), and has a size of Mᵢ×Kᵢ.

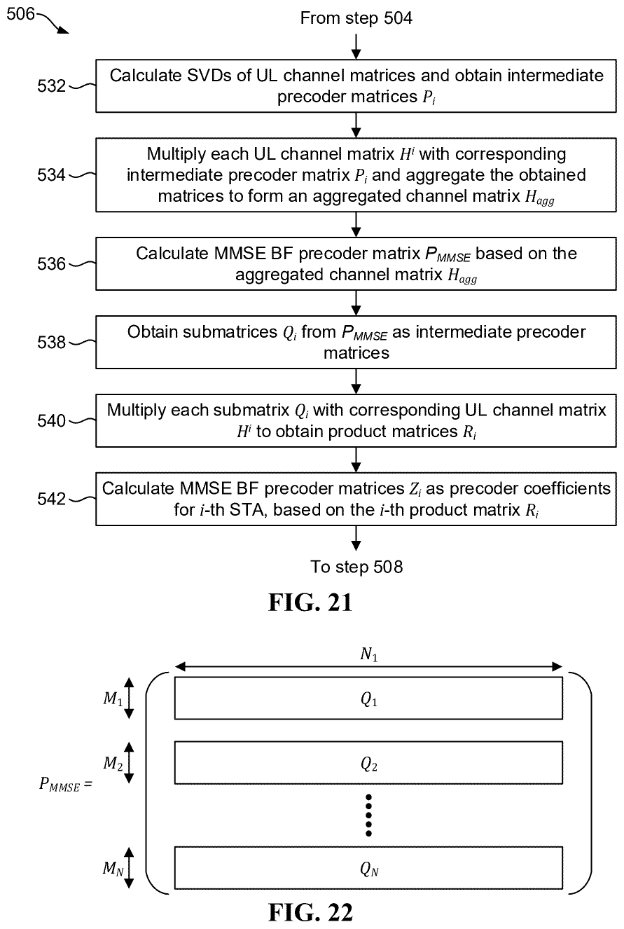

FIG. 21 shows the detail of the precoder-computation step 506, according to some embodiments of this disclosure. Compared to the precoder computation in the embodiments shown in FIG. 19, the precoder computation in these embodiments may provide improved performance.

At step 532, the AP 102 calculates the singular value decomposition (SVD) of each estimated channel matrix

$${H}_{{N}_{1} \times {M}_{i}}^{i} ( i = 1 , ... , N ) ,$$

that is,

$${H}_{{N}_{1} \times {M}_{i}}^{i} = {U}_{i} {D}_{i} {P}_{i} ,$$

where Uᵢ is the left singular matrix, Dᵢ is a diagonal matrix whose diagonal entries are the singular values of

$${H}_{{N}_{1} \times {M}_{i}}^{i} ,$$

and Pᵢ is the right singular matrix. The right singular matrix Pᵢ, i=1, . . . , N of each SVD output is then used as the intermediate precoder matrix for the corresponding UL channel.

At step 534, the AP 102 multiplies each estimated channel matrix

$${H}_{{N}_{1} \times {M}_{i}}^{i}$$

with the corresponding intermediate precoder matrix Pᵢ, and aggregates the obtained matrices

$${H}_{{N}_{1} \times {M}_{i}}^{i} {P}_{i}$$

to obtain the aggregated channel matrix H_{agg} as:

$${H}_{agg} = [ \begin{matrix}{H}_{{N}_{1} \times {M}_{1}}^{1} {P}_{1} & {H}_{{N}_{1} \times {M}_{2}}^{2} {P}_{2} & ⋯ & {H}_{{N}_{1} \times {M}_{N}}^{N} {P}_{N}\end{matrix} ]$$

where the size of H_{agg} is N₁×(M₁+M₂+ . . . +M_{N}).

At step 536, the AP 102 calculates the MMSE BF precoder matrix P_{MMSE} based on the aggregated channel matrix H_{agg} as:

$${P}_{MMSE} = {{H}_{agg}^{H} ( {H}_{agg} {H}_{agg}^{H} + ρ )}^{- 1}$$

where ρ is a N₁×N₁ diagonal matrix with each diagonal element being the SNR measured at each Rx chain of the AP 102. The size of P_{MMSE} is (M₁+M₂+ . . . +M_{N})×N₁.

At step 538 (also referring to FIG. 22), the MMSE BF precoder matrix P_{MMSE} is partitioned into a plurality of MMSE BF precoder submatrices Q₁, Q₂, . . . , Q_{N} with their sizes being M₁×N₁, M₂×N₁, . . . , M_{N}×N₁, respectively (in other words, Q₁ contains the first Mᵢ rows of P_{MMSE}, Q₁ contains the next M₂ rows of P_{MMSE}, . . . , Q_{N} contains the last MN rows of P_{MMSE}).

At step 540, the AP 102 multiplies each MMSE BF precoder submatrix Qᵢ with the corresponding estimated channel matrix

$${H}_{{N}_{1} \times {M}_{i}}^{i} ,$$

thereby obtaining a plurality of product matrices

$${Q}_{1} {H}_{{N}_{1} \times {M}_{1}}^{1} , {Q}_{2} {H}_{{N}_{1} \times {M}_{2}}^{2} , … , {Q}_{N} {H}_{{N}_{1} \times {M}_{N}}^{N} .$$

At step 542, a MMSE BF precoder matrix

$${P}_{MMSE}^{i}$$

is calculated based on the i-th product matrix:

$${Z}_{i} = {{R}_{i}^{H} ( {R}_{i} {R}_{i}^{H} + ρ )}^{- 1}$$

where

$${R}_{i} = {Q}_{i} {H}_{{N}_{1} \times {M}_{i}}^{i} , i = 1 , … , N .$$

The i-th MMSE BF precoder matrix Zᵢ has a size of Mᵢ×Mᵢ.

The precoder-coefficients submatrix Sᵢ for the i-th STA is the upper-left Mᵢ×Kᵢ submatrix of Zᵢ containing the values in the first Mᵢ rows and first Kᵢ columns of Zᵢ. The AP 102 thus obtains the precoder-coefficients submatrix Sᵢ (for i=1, . . . , N) and goes to step 508 to feed back the obtained precoder-coefficients Sᵢ, i=1, . . . , N, to the respective STAs. More specifically, S₁ (which is the M₁×K₁ submatrix of Z₁) is fed back to the first STA (STA 1) as its precoder coefficients, S₂ (which is the M₂×K₂ submatrix of Z₂) is fed back to the second STA (STA 2) as its precoder coefficients, and S_{N} (which is the M_{N}×K_{N} submatrix of Z_{N}) is fed back to the N-th STA (STA N) as its precoder coefficients, where Kᵢ represents the actual number of streams to be UL-transmitted from the i-th STA.

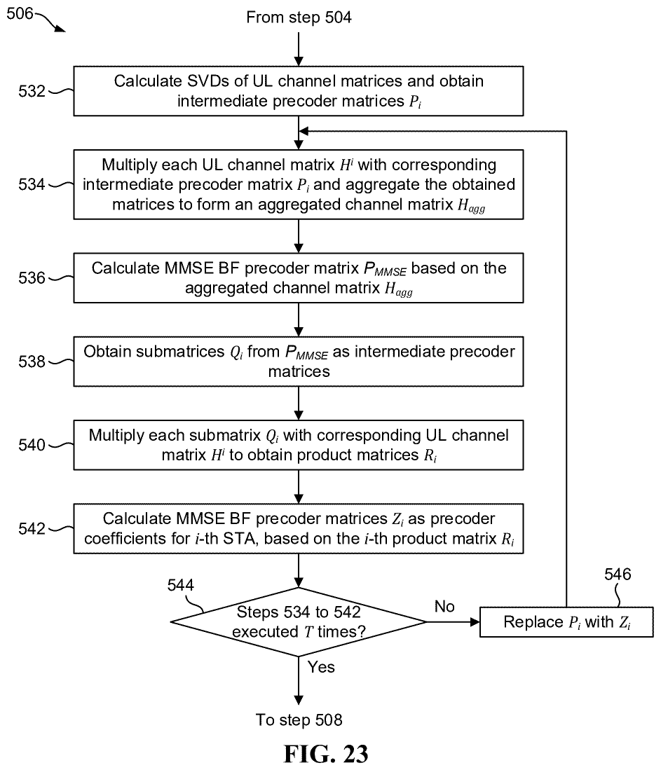

FIG. 23 shows the detail of the precoder-computation step 506, according to some other embodiments of this disclosure. Compared to the precoder computation in the embodiments shown in FIG. 21, the precoder computation in these embodiments may provide improved performance.

The precoder-computation step 506 in these embodiments is similar to that shown in FIG. 21 except that, in these embodiments, the AP 102 may replace the intermediate precoder matrices P₁, P₂, . . . , P_{N} respectively with the MMSE BF precoder matrices Z₁, Z₂, . . . , Z_{N} obtained at step 542, and repeat steps 534 to 542 for one or more times (represented by steps 544 and 546) such that steps 534 to 542 may be executed for T times where T>1 is an integer. For example, in some embodiments, steps 534 to 542 may be executed two times (that is, T=2). In some other embodiments, steps 534 to 542 may be executed more than two times (that is, T>2). Similar to the embodiments shown in FIG. 21, the precoder-coefficients submatrix Sᵢ for the i-th STA is the Mᵢ×Kᵢ submatrix of Zᵢ.

Those skilled in the art will appreciate that the precoder coefficients frame structures and the methods of computing the precoder coefficients disclosed herein do not have to be used together. For example, in some embodiments, the precoder coefficients frame structure disclosed herein may be used for transmitting precoder coefficients calculated using other suitable methods. In some other embodiments, the precoder coefficients calculated using the methods disclosed herein may be transmitted using other suitable precoder coefficients frame structures.

By using the UL channel estimation method disclosed herein, a plurality of STAs 112 may use the precoder coefficients for beamforming to transmit their data frames to the AP 102 simultaneously in an UL MU-MIMO manner. The UL channel estimation method disclosed herein may be used in a variety of systems such as WI-FI® 8.

C. ACRONYM KEY

| Acronym | Full Name |
|---|---|
| UL | Uplink |
| MU | Multi-User |
| MIMO | Multiple Input Multiple Output |
| BF | Beamforming |
| FB | Feedback |
| HE | High Efficiency (11ax, WI-FI ® 6) |
| UHR | Ultra High Reliability (WI-FI ® 8) |
| EHT | Extremely High Throughput (11be, WI-FI ® 7) |
| AP | Access Point |
| NDP | Null Data Packet |
| SIFS | Short Inter-Frame Space |
| MMSE | Minimum Mean Squared Error |
| STA | Station |
| BW | Bandwidth |
| HT | High Throughput |
| VHT | Very High Throughput |
| Nc | Number of Columns |
| Nr | Number of Rows |
| RU | Resource Unit |
| AID | Association Identification |
| PC | Precoder Coefficients |
| TX | Transmitter |
| RX | Receiver |
| SVD | Singular Value Decomposition |

Although embodiments have been described above with reference to the accompanying drawings, those of skill in the art will appreciate that variations and modifications may be made without departing from the scope thereof as defined by the appended claims.

1. A method comprising:
transmitting to a plurality of stations (STAs) or receiving from an access point (AP) a plurality of sets of precoder coefficients and a trigger for uplink (UL) data transmission;
wherein one set of the plurality of sets of precoder coefficients is used for beamforming to transmit data to the AP; and
wherein each set of precoder coefficients are obtained based on parameters of one or more estimated channels between an access point (AP) and a respective STA of the plurality of STAs.

2. The method of claim 1, wherein the one or more sets of precoder coefficients are organized in a frame or sub-frame;
wherein the frame or sub-frame comprises a control field, and one or more precoder coefficients fields each comprising a respective one of the one or more sets of the precoder coefficients; and
wherein the control field comprises a plurality of STA-control subfields each corresponding to a respective one of the plurality of STAs.

3. The method of claim 2, wherein each STA-control subfield at least comprises:
an association-identification (AID) subfield comprising an identifier (ID) of the corresponding STA;
a Nc-index subfield and a Nr-index subfield for indicating a number of columns and a number of rows of a beamforming feedback matrix, respectively;
a grouping subfield for indicating subcarrier grouping; and
a codebook-information subfield for indicating a size of codebook entries; and
wherein each STA-control subfield further comprises a sounding-dialog-token-number subfield for identifying a null data packet (NDP) announcement frame for the corresponding STA, or the control field further comprises a sounding-dialog-token-number subfield for identifying a NDP announcement frame for the plurality of STAs.

4. The method of claim 1 further comprising:
(i) calculating a SVD of each of a plurality of estimated channel matrices each comprising the parameters of the one or more estimated channels between the AP and the plurality of STAs to obtain a first precoder matrix for each of the plurality of STAs;
(ii) obtaining a plurality of first product matrices each being a multiplication of one of the plurality of estimated channel matrices and the corresponding first precoder matrix;
(iii) calculating a second precoder matrix based on an aggregated channel matrix comprising the plurality of first product matrices;
(iv) obtaining a plurality of submatrices from the precoder matrix;
(v) obtaining a plurality of second product matrices each being a multiplication of one of the plurality of submatrix and the corresponding estimated channel matrix;
(vi) calculating a plurality of third precoder matrices each based on a corresponding one of the plurality of second product matrices; and
(vii) obtaining each set of precoder coefficients as values of a submatrix of a corresponding one of the plurality of third precoder matrices.

5. The method of claim 4 further comprising:
performing the following steps for at least once before performing step (vii):
(vi-1) replacing values of the first precoder matrices with those of the third precoder matrices; and
(vi-2) repeating steps (ii) to (vi).

6. An apparatus comprising:
one or more processors functionally connected to one or more memories storing instructions, and the one or more processors is configured to execute the instructions and cause the apparatus to perform the method of claim 1.

7. The apparatus of claim 6, wherein the one or more sets of precoder coefficients are organized in a frame or sub-frame;
wherein the frame or sub-frame comprises a control field, and one or more precoder coefficients fields each comprising a respective one of the one or more sets of the precoder coefficients; and
wherein the control field comprises a plurality of STA-control subfields each corresponding to a respective one of the plurality of STAs.

8. The apparatus of claim 7, wherein each STA-control subfield at least comprises:
an association-identification (AID) subfield comprising an identifier (ID) of the corresponding STA;
a Nc-index subfield and a Nr-index subfield for indicating a number of columns and a number of rows of a beamforming feedback matrix, respectively;
a grouping subfield for indicating subcarrier grouping; and
a codebook-information subfield for indicating a size of codebook entries; and
wherein each STA-control subfield further comprises a sounding-dialog-token-number subfield for identifying a null data packet (NDP) announcement frame for the corresponding STA, or the control field further comprises a sounding-dialog-token-number subfield for identifying a NDP announcement frame for the plurality of STAs.

9. The apparatus of claim 6, wherein the method further comprises:
(i) calculating a SVD of each of a plurality of estimated channel matrices each comprising the parameters of the one or more estimated channels between the AP and the plurality of STAs to obtain a first precoder matrix for each of the plurality of STAs;
(ii) obtaining a plurality of first product matrices each being a multiplication of one of the plurality of estimated channel matrices and the corresponding first precoder matrix;
(iii) calculating a second precoder matrix based on an aggregated channel matrix comprising the plurality of first product matrices;
(iv) obtaining a plurality of submatrices from the precoder matrix;
(v) obtaining a plurality of second product matrices each being a multiplication of one of the plurality of submatrix and the corresponding estimated channel matrix;
(vi) calculating a plurality of third precoder matrices each based on a corresponding one of the plurality of second product matrices; and
(vii) obtaining each set of precoder coefficients as values of a submatrix of a corresponding one of the plurality of third precoder matrices.

10. One or more non-transitory computer-readable storage devices comprising computer-executable instructions, wherein the instructions, when executed, cause one or more circuits to perform the method of claim 1.

11. The one or more non-transitory computer-readable storage devices of claim 10, wherein the one or more sets of precoder coefficients are organized in a frame or sub-frame;
wherein the frame or sub-frame comprises a control field, and one or more precoder coefficients fields each comprising a respective one of the one or more sets of the precoder coefficients; and
wherein the control field comprises a plurality of STA-control subfields each corresponding to a respective one of the plurality of STAs.

12. The one or more non-transitory computer-readable storage devices of claim 11, wherein each STA-control subfield at least comprises:
an association-identification (AID) subfield comprising an identifier (ID) of the corresponding STA;
a Nc-index subfield and a Nr-index subfield for indicating a number of columns and a number of rows of a beamforming feedback matrix, respectively;
a grouping subfield for indicating subcarrier grouping; and
a codebook-information subfield for indicating a size of codebook entries.

13. The one or more non-transitory computer-readable storage devices of claim 12, wherein each STA-control subfield further comprises a sounding-dialog-token-number subfield for identifying a null data packet (NDP) announcement frame for the corresponding STA; or
wherein the control field further comprises a sounding-dialog-token-number subfield for identifying a NDP announcement frame for the plurality of STAs.

14. The one or more non-transitory computer-readable storage devices of claim 12, wherein each STA-control subfield further comprises:
a remaining-feedback-segments subfield;
a first-feedback-segment subfield; and
a resource-unit allocation subfield.

15. The one or more non-transitory computer-readable storage devices of claim 12, wherein the frame or sub-frame comprises a plurality of precoder coefficients fields, and each neighboring pair of precoder coefficients fields are separated by a second delimiter field; and
wherein each second delimiter field comprises a same content as the AID subfield of a preceding STA-control subfield.

16. The one or more non-transitory computer-readable storage devices of claim 10, wherein each set of precoder coefficients correspond to values of a submatrix of a precoder matrix;
wherein the precoder matrix is calculated based on an aggregated channel matrix comprising the parameters of the one or more estimated channels between the AP and each of the plurality of STAs;
wherein the precoder matrix is a precoder matrix P_{MMSE} for all sets of precoder coefficients;
wherein the precoder matrix P_{MMSE} is calculated as:
$${P}_{MMSE} = {{H}_{agg}^{H} ( {H}_{agg} {H}_{agg}^{H} + ρ )}^{- 1}$$
where superscript H represents a Hermitian operation, superscript −1 represents a matrix inverse operation, ρ is a N₁×N₁ diagonal matrix with each diagonal element being a signal-to-noise ratio (SNR) measured at a receiver chain of the AP, Mᵢ≥1 is an integer representing a total number of antennas of the AP, a size of P_{MMSE} is (M₁+M₂+ . . . +M_{N})×N₁, (M₁+M₂+ . . . +M_{N})≤N₁, N≥1 is an integer representing a total number of the STAs, Mᵢ≥1 (i=1, 2, . . . , N) is an integer representing a total number of antennas of the i-th STA, and H_{agg} is the aggregated channel matrix:
$${H}_{agg} = [ \begin{matrix}{H}_{{N}_{1} \times {M}_{1}}^{1} & {H}_{{N}_{1} \times {M}_{2}}^{2} & ⋯ & {H}_{{N}_{1} \times {M}_{N}}^{N}\end{matrix} ]$$
where
$${H}_{{N}_{1} \times {M}_{i}}^{i} ,$$
is an i-th estimated channel matrix comprising the parameters of the one or more estimated channels between the AP and the i-th STA, and the size of H_{agg} is N₁×(M₁+M₂+ . . . +M_{N}); and
wherein the i-th set of precoder coefficients correspond to the values of the submatrix of the precoder matrix P_{MMSE} from
$$( {\sum }_{j = 0}^{i - 1} {M}_{j} + 1 ) - th$$
row and the
$$( {\sum }_{j = 0}^{i - 1} {M}_{j} + 1 ) - th$$
column of the precoder matrix P_{MMSE} and having a size of Mᵢ×Ki, where M₀=0, Kᵢ represents a total number of spatial streams transmitted by the i-th STA to the AP, Kᵢ≤Mᵢ.

17. The one or more non-transitory computer-readable storage devices of claim 10, wherein each set of precoder coefficients correspond to values of a submatrix of a precoder matrix;
wherein the precoder matrix is calculated based on an aggregated channel matrix comprising the parameters of the one or more estimated channels between the AP and each of the plurality of STAs;
wherein the i-th set of precoder coefficients correspond to values in first Mᵢ rows and first Kᵢ columns of an i-th precoder matrix Zᵢ having a size of Mᵢ×Mᵢ, i=1, 2, . . . , N, N≥1 is an integer representing a total number of the STAs, Mᵢ≥1 is an integer representing a total number of antennas of the i-th STA, (M₁+M₂+ . . . +M_{N})≤N₁, N₁≥1 is an integer representing a total number of antennas of the AP, Kᵢ represents a total number of spatial streams transmitted by the i-th STA to the AP, Kᵢ≤Mᵢ; and
wherein the i-th precoder matrix Zᵢ is calculated as:
$${Z}_{i} = {{R}_{i}^{H} ( {R}_{i} {R}_{i}^{H} + ρ )}^{- 1}$$
where superscript H represents a Hermitian operation, superscript −1 represents a matrix inverse operation, ρ is a N₁×N₁ diagonal matrix with each diagonal element being a SNR measured at a receiver chain of the AP,
$${R}_{i} = {Q}_{i} {H}_{{N}_{1} \times {M}_{i}}^{i} , {Q}_{i}$$
contains containing Mᵢ rows a matrix P_{MMSE} having a size of (M₁+M₂+ . . . +M_{N})×N₁ and
$${P}_{MMSE} = [ \begin{matrix}{Q}_{1} \\ \begin{matrix}⋮ \\ {Q}_{{N}_{1}}\end{matrix}\end{matrix} ] ,$$
$${P}_{MMSE} = {{H}_{agg}^{H} ( {H}_{agg} {H}_{agg}^{H} + ρ )}^{- 1} ,$$
where H_{agg} is the aggregated channel matrix having a size of N₁×(M₁+M₂+ . . . +M_{N}):
$${H}_{agg} = [ \begin{matrix}{H}_{{N}_{1} \times {M}_{1}}^{1} {P}_{1} & {H}_{{N}_{1} \times {M}_{2}}^{2} {P}_{2} & … & {H}_{{N}_{1} \times {M}_{N}}^{N} {P}_{N}\end{matrix} ]$$
where
$${H}_{{N}_{1} \times {M}_{i}}^{i}$$
is an i-th estimated channel matrix comprising the parameters of the one or more estimated channels between the AP and the i-th STA, and Pᵢ is a right singular matrix of a singular value decomposition (SVD) of
$${H}_{{N}_{1} \times {M}_{i}}^{i} :$$
$${H}_{{N}_{1} \times {M}_{i}}^{i} = {U}_{i} {D}_{i} {P}_{i}$$
where Uᵢ is a left singular matrix, and Dᵢ is a diagonal matrix whose diagonal entries are singular values of
$${H}_{{N}_{1} \times {M}_{i}}^{i} .$$

18. The one or more non-transitory computer-readable storage devices of claim 10, wherein each set of precoder coefficients correspond to values of a submatrix of a precoder matrix;
wherein the precoder matrix is calculated based on an aggregated channel matrix comprising the parameters of the one or more estimated channels between the AP and each of the plurality of STAs;
wherein the i-th set of precoder coefficients (i=1, 2, . . . , N, N≥1 is an integer representing a total number of the STAs) are calculated by:
(i) calculating a SVD of an i-th estimated channel matrix
$${H}_{{N}_{1} \times {M}_{i}}^{i}$$
comprising the parameters of the one or more estimated channels between the AP and the i-th STA as:
$${H}_{{N}_{1} \times {M}_{i}}^{i} = {U}_{i} {D}_{i} {P}_{i}$$
where N₁≥1 is an integer representing a total number of antennas of the AP, Mᵢ≥1 (i=1, 2, . . . , N) is an integer representing a total number of antennas of the i-th STA, (M₁+M₂+ . . . +M_{N})≤N₁, Uᵢ is a left singular matrix, Dᵢ is a diagonal matrix whose diagonal entries are singular values of
$${H}_{{N}_{1} \times {M}_{i}}^{i} ,$$
and Pᵢ a right singular matrix;
(ii) obtaining the aggregated channel matrix H_{agg} as:
$${H}_{agg} = [ \begin{matrix}{H}_{{N}_{1} \times {M}_{1}}^{1} {P}_{1} & {H}_{{N}_{1} \times {M}_{2}}^{2} {P}_{2} & … & {H}_{{N}_{1} \times {M}_{N}}^{N} {P}_{N}\end{matrix} ]$$
where H_{agg} has a size of N₁×(M₁+M₂+ . . . +M_{N});
(iii) calculating a matrix P_{MMSE} having a size of (M₁+M₂+ . . . +M_{N})×N₁ as:
$${P}_{MMSE} = {{H}_{agg}^{H} ( {H}_{agg} {H}_{agg}^{H} + ρ )}^{- 1}$$
where superscript H represents a Hermitian operation, superscript −1 represents a matrix inverse operation, ρ is a N₁×N₁ diagonal matrix with each diagonal element being a SNR measured at a receiver chain of the AP;
(iv) obtaining a plurality of submatrices Q₁, . . . , Q_{N} from the matrix P_{MMSE} where Qᵢ contains containing Mᵢ rows of the matrix P_{MMSE} and
$${P}_{MMSE} = [ \begin{matrix}{Q}_{1} \\ \begin{matrix}⋮ \\ {Q}_{{N}_{1}}\end{matrix}\end{matrix} ] ;$$
(v) calculating:
$${Z}_{i} = {{R}_{i}^{H} ( {R}_{i} {R}_{i}^{H} + ρ )}^{- 1}$$
where
$${R}_{i} = {Q}_{i} {H}_{{N}_{1} \times {M}_{i}}^{i} ,$$
Zᵢ is a matrix having a size of Mᵢ×Mᵢ;
(vi) replacing Pᵢ with Zᵢ;
(vii) repeating steps (ii) to (v) for at least once; and
(viii) obtaining a matrix Sᵢ containing values in first Mᵢ rows and first Kᵢ columns of the matrix Zᵢ, the values of the matrix Sᵢ being the i-th set of precoder coefficients.

19. The one or more non-transitory computer-readable storage devices of claim 10, wherein the method further comprises:
(i) calculating a SVD of each of a plurality of estimated channel matrices each comprising the parameters of the one or more estimated channels between the AP and the plurality of STAs to obtain a first precoder matrix for each of the plurality of STAs;
(ii) obtaining a plurality of first product matrices each being a multiplication of one of the plurality of estimated channel matrices and the corresponding first precoder matrix;
(iii) calculating a second precoder matrix based on an aggregated channel matrix comprising the plurality of first product matrices;
(iv) obtaining a plurality of submatrices from the precoder matrix;
(v) obtaining a plurality of second product matrices each being a multiplication of one of the plurality of submatrix and the corresponding estimated channel matrix;
(vi) calculating a plurality of third precoder matrices each based on a corresponding one of the plurality of second product matrices; and
(vii) obtaining each set of precoder coefficients as values of a submatrix of a corresponding one of the plurality of third precoder matrices.

20. The one or more non-transitory computer-readable storage devices of claim 19, wherein the method further comprises:
performing the following steps for at least once before performing step (vii):
(vi-1) replacing values of the first precoder matrices with those of the third precoder matrices; and
(vi-2) repeating steps (ii) to (vi).
